(19) United States
(12) Patent Application Publication
(10) Pub. No.: US 2006/0193220 A1
(43) Pub. Date: Aug. 31, 2006

(54) Optical head unit and optical disc apparatus

(76) Inventors: Katsuo Iwata, Yokohama-Shi (JP); Kazuhiro Nagata, Yokohama-Shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/363,606

(22) Filed: Feb. 28, 2006

(30) Foreign Application Priority Data
Feb. 28, 2005 (JP) 2005-055076

(51) Int. Cl. G11B 7/00

(52) U.S. Cl. 369/44.41

(57) ABSTRACT

To provide an optical pickup and an optical disc apparatus which obtains stable reproduce signal when reproducing information from a recording medium of a standard handled by selectively using laser beams with different wavelengths, use a diffraction grating having a diffraction pattern defined according to a laser beam with a first wavelength, and when a laser beam with a second wavelength different from a first wavelength passes, obtain an RF signal by adding a non-diffracted light and diffracted light to an output signal.

### CROSS-REFERENCE TO RELATED APPLICATIONS

This application is based upon and claims the benefit of priority from prior Japanese Patent Application No. 2005-055076, filed Feb. 28, 2005, the entire contents of which are incorporated herein by reference.

### BACKGROUND

1. Field

One embodiment of the invention relates to an optical disc apparatus which records or reproduces information on/from an optical information recording medium or an optical disc, and an optical head unit incorporated in the optical disc apparatus.

2. Description of the Related Art

A long time has been passed since the commercialization of an optical disc capable of recording or reproducing information in a noncontact manner by using a laser beam, and an optical disc apparatus (an optical disc drive) which is capable of recording and reproducing information on/from an optical disc. Optical discs with several kinds of recording density called CD and DVD have become popular.

Recently, an ultra-high density optical disc called a HD DVD using a laser beam with a blue or blue-purple wavelength to record information to increase the recording density, is going to be commercially used.

An optical disc apparatus includes a light transmitting system to radiate a laser beam with a fixed wavelength to a specified position on an optical disc (a recording medium), a light receiving system to detect a laser beam reflected on an optical disc, a mechanism control (servo) system to control the operations of the light transmitting system and light receiving system, and a signal processing system which supplies recording information and an erase signal to the light transmitting system, and reproduces recorded information from a signal detected by the light receiving system. Compact and lightweight design is highly demanded for an optical head unit incorporated with a light transmitting system, a light receiving system and a servo system in one body.

Optical discs based on DVD and HD DVD standards have more than one recording layer.

Further, a recordable HD DVD disc has a light reflectivity lower than that of a recordable DVD disc. As a laser beam with a short wavelength is used to increase the recording density, the transmissivity of the optical elements used in the light transmitting system and light receiving system tends to be lowered. Thus, the intensity of a laser beam reflected from a recording layer is weak compared with an optical disc of CD standard used widely.

Diffraction components obtained by diffracting and dividing a reflected laser beam from an optical disc by a diffraction grating has been widely used to detect a focus error amount and a track error amount for the tracking and focus control of an objective lens of an optical head unit, realizing stable recording/reproduce for several kinds of disc including DVD and CD.

It is disclosed by, for example, Japanese Patent Application Publication (KOKAI) No. 8-22624 discloses a method of obtaining a focus error signal from a +1st-order diffraction light diffracted by using a polarized anisotropic hologram, and obtaining a track error signal from a −1st-order diffraction light of the same diffraction light.

However, when the polarized anisotropic hologram described in the above document is used, a 0th-order signal cannot be used for reproduce, focus control or tracking control. As a polarized anisotropic hologram depends largely on a wavelength, when the wavelength of a light source is changed, a 0th-order diffraction efficiency/±1st-order diffraction efficiency is changed. Thus, even when using a polarized anisotropic hologram which maximizes ±1st-order diffraction efficiency for the recording/reproduce of a HD DVD optical disc, it is desirable to use a 0th-order diffraction light, because when the wavelength of a light source is changed, the 0th-order diffraction efficiency is increased while the ±1st-order diffraction efficiency is decreased.

The diffraction efficiency of ±1st-order light is decreased not only for optical discs of HD DVD standard but also for optical discs based on DVD and CD standards, while the diffraction efficiency of 0th-order light is increased. Therefore, it is desirable to use not only ±1st-order diffraction light but also 0th-order diffraction light especially when reproducing several kinds of discs and controlling the focus and track error.

Though there is a problem that reproduce of a signal from an optical disc with a low intensity of a reflected laser beam from a recording layer is weak becomes unstable (the signal-to-noise ratio of a reproduce signal is decreased), like in a HD DVD standard optical disc, use of both ±1st-order diffraction light and 0th-order diffraction light enables stable recording/reproduce of not only a HD DVD standard optical disc but also DVD/CD standard optical discs.

The wavelength of a laser beam used for recording, reproducing and erasing information on/from an HD DVD standard optical disc is 400-410 nm, and a signal detection system (a photodetector) and signal processing system capable of ensuring high signal-to-noise ratio is not established at present. Namely, it is also very difficult to design a signal processing circuit used for processing a signal component obtained from a detected reflected laser beam.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus according to the first embodiment of the invention;

FIG. 2 is an exemplary diagram showing an image-focusing relationship between an optical dividing element and a photodetector in an optical head unit of the optical disc apparatus shown in FIG. 1, and an example of combination of RF output signals;

FIG. 3 is a graph explaining an exemplary the relationship between the wavelength of a laser beam from a laser element and the diffraction efficiency (binary type) in the optical head unit shown in FIG. 1;

FIG. 4 is a graph explaining an exemplary the relationship between the wavelength of a laser beam from a laser element and the diffraction efficiency (blaze type) in the optical head unit shown in FIG. 1;

FIG. 5 is an exemplary diagram showing an example of another embodiment of the optical disc apparatus shown in FIG. 1;

FIG. 6 is a graph explaining an exemplary the relationship between the wavelength of a laser beam and the diffraction efficiency (binary type) when the diffraction grating shown in FIG. 3 is applied to the optical disc apparatus shown in FIG. 5;

FIG. 7 is a graph explaining an exemplary the relationship between the wavelength of a laser beam and the diffraction efficiency (blaze type) when the diffraction grating shown in FIG. 4 is applied to the optical disc apparatus shown in FIG. 5;

FIG. 8 is a graph explaining an exemplary the relationship between the depth of a groove of a diffraction grating and the diffraction efficiency (binary type) when the diffraction grating shown in FIG. 3 is applied to the optical disc apparatus shown in FIG. 5;

FIG. 9 is a graph explaining an exemplary the relationship between the depth of a groove of a diffraction grating and the diffraction efficiency (blaze type) when the diffraction grating shown in FIG. 4 is applied to the optical disc apparatus shown in FIG. 5;

FIG. 10 is a graph explaining an exemplary the changes in RF output (wavelength-dependent) when the diffraction grating (binary type) shown in FIG. 3 is applied to the optical disc apparatus shown in FIG. 5;

FIG. 11 is a graph explaining an exemplary the changes in RF output (wavelength-dependent) when the diffraction grating (blaze type) shown in FIG. 4 is applied to the optical disc apparatus shown in FIG. 5;

FIG. 12 is a graph explaining an exemplary the changes in RF output (groove-depth-dependent) when the diffraction grating (binary type) shown in FIG. 3 is applied to the optical disc apparatus shown in FIG. 5; and

FIG. 13 is a graph explaining an exemplary the changes in RF output (groove-depth-dependent) when the diffraction grating (blaze type) shown in FIG. 4 is applied to the optical disc apparatus shown in FIG. 5.

### DETAILED DESCRIPTION

Various embodiments according to the invention will be described hereinafter with reference to the accompanying drawings. In general, according to one embodiment of the invention, an optical pickup and an optical disc apparatus which obtains stable reproduce signal when reproducing information from a recording medium of a standard handled by selectively using laser beams with different wavelengths, use a diffraction grating having a diffraction pattern defined according to a laser beam with a first wavelength, and when a laser beam with a second wavelength different from a first wavelength passes, obtain an RF signal by adding a non-diffracted light and diffracted light to an output signal.

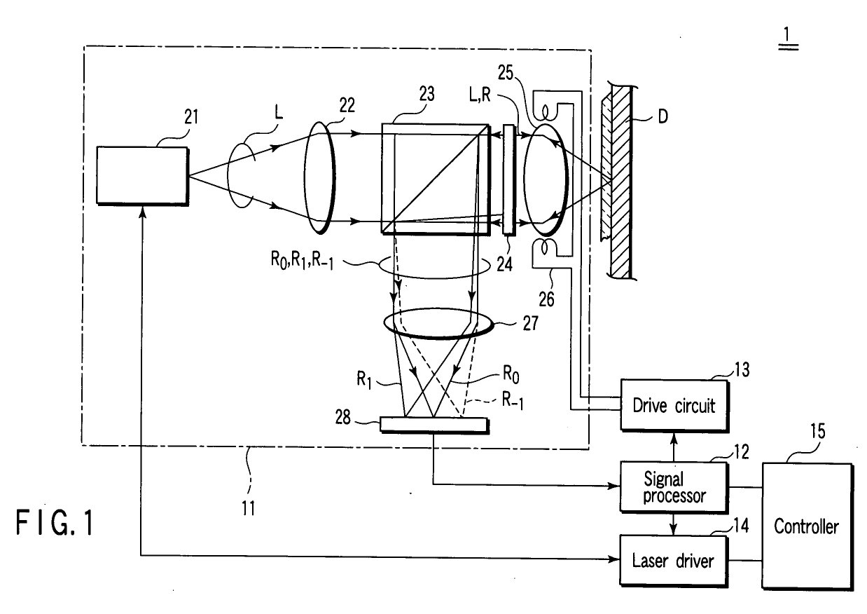

According to an embodiment, FIG. 1 shows an example of the configuration of an information recording/reproduce apparatus (an optical disc apparatus) to which the embodiments of the invention are applicable.

An optical disc apparatus 1 shown in FIG. 1 includes an optical pickup unit (an optical head unit) 11 which can record information on a recording medium (an optical disc) D, read information recorded on an optical disc, or erase information recorded on an optical disc. Though not described in detail, in addition to the optical head unit 11, the optical disc apparatus is of course incorporated with mechanical elements, such as, a head moving mechanism for moving the optical head unit 11 along the recording surface of the optical disc D, and a disc motor (not shown) for rotating an optical disc at a fixed speed.

The optical head unit 11 includes a light source, or a laser diode (LD) 21 that is a semiconductor laser element, for example. The wavelength of a laser beam emitted from the LD (light source) 21 is 400-410 nm, preferably, 405 nm.

A laser beam from the LD (light source) 21 is collimated to be a parallel beam by a collimator lens 22, passed through a polarization beam splitter (PBS) 23 and an optical dividing element or hologram diffraction element (HOE) 24 provided at predetermined positions, and given a fixed convergence by an objective lens (OL) 25. The objective lens 25 is made of plastic, and has a numerical aperture (NA) of 0.65, for example.

The laser beam given the fixed convergence by the objective lens 25 is passed through a not-described cover layer of an optical disc, and condensed on the recording layer or close to there. (The laser beam from the light source 21 provides a smallest optical spot at the focal position of the objective lens 25.) The objective lens 25 is placed at a fixed position on a track of a recording surface of an optical disc by an objective lens drive 26 consisting of a driving coil and a magnet, for example. The smallest optical spot of a laser beam is condensed on the recording layer of the optical disc D by moving the objective lens 25 (optical head unit 11) in the direction (optical axis direction) orthogonal to the recording surface by a known focus control, for example, so that the distance from the objective lens 25 to the recording surface of the optical disc D becomes identical to the focal distance of the objective lens 25.

A laser beam reflected on the information recording surface of the optical disc D is captured and converted by the objective lens 25 to have a substantially parallel sectional beam shape, and returned to the polarization beam splitter 23.

The reflected laser beam returned to the polarization beam splitter 23 passes through a not-shown ¼ wavelength plate 24, and reflected on a not-described polarizing surface of the polarization beam splitter 23, because the polarizing direction of the laser beam advancing to the optical disc D is rotated by 90°.

The laser beam reflected by the polarization beam splitter 23 is focused as an image on the light-receiving surface of a photodiode (photodetector) 28 through a focusing lens 27.

The reflected laser beam is divided into a specified shape and number of portions to meet the arrangement of detection areas (light-receiving areas) and shape given previously on the light-receiving surface of a photodetector 28 provided in a later stage, when passing through the hologram diffaction element 24.

The current output from each light-receiving part of the photodetector 28 is converted into a voltage by a not-shown I/V amplifier, and processed by a signal processing unit 12 to be usable for a RF (reproduce) signal, a focus error signal and a track error signal.

An RF signal is converted into a specified signal format under the control of a controller (main control unit) 15, or through a specified interface, and outputted to a temporary storage or an external storage, though not described in detail.

Signals concerning the position of the objective lens 25 among the outputs of the signal processing unit 12, that is, a focus error signal and an track error signal are converted into a focus control signal and a tracking control signal to correct the position of the objective lens 15 in the signal processing unit 12 or controller 15, and supplied to a lens driving circuit 13.

Based on the signal concerning the intensity of laser beam among the outputs of the signal processing unit 12, and an instruction to reproduce or erase recorded data supplied through the controller 15, the intensity of the laser beam output from the laser diode 21 is controlled (the driving current supplied to the laser diode 21 is sequentially changed).

The signal obtained from the signal processing unit 12 is used also for a servo signal for moving the objective lens 25 in the direction (optical axis direction) orthogonal to the surface including the recording surface of an optical disc, so that the distance from the objective lens 25 to the recording surface of the optical disc D becomes identical to the focal distance of the objective lens 25, and in the direction orthogonal to the extending direction of the track or record mark (string) formed previously on the recording surface of an optical disc.

A servo signal is generated based on a track error signal indicating a change in the position of the objective lens 25 and a known method of detecting a track error (error), so that an optical spot having a specified size at the focal position of the objective lens 25 becomes the specified size on the recording layer of the optical disc D according to a known focus error (error) detection method, and the optical spot is guided at substantially the center of the recording mark string or track according to a known track error (error) detection method.

Namely, the objective lens 25 is controlled, so that a smallest optical spot condensed by the objective lens 25 can be provided at substantially the center of the track or record mark string formed on the not-shown recording layer of the optical disc D in its focal distance.

More particularly, a laser beam L emitted from the semiconductor laser 21 is collimated by the collimator lens 22. The laser beam L is a linearly polarized light, passed through PBS (polarization beam splitter) 23 and hologram (HOE) 24, changed (rotated) in the polarizing surface to a circularly polarized light by the not-shown ¼ wavelength plate, given a fixed convergence when passed through the objective lens 25, and condensed on the recording surface of the optical disc D.

The laser beam L condensed on the recording surface of the optical disc D is optically modulated by (being reflected or diffracted by) the record mark (pit string) formed on the recording surface or a groove formed previously on the recording surface of an optical disc.

The laser beam R reflected or diffracted on the recording surface of an optical disc is captured by the objective lens 25, substantially paralleled when outputted, and the polarizing direction is changed by 90° compared with an advancing path by passing through the not-shown ¼ wavelength plate, and returned to the hologram diffraction element (HOE) 24.

The hologram diffraction element 24 has a polarizing pattern that is acted only to the polarized light (reflected laser beam R) in a returning path, divides the reflected laser beam R into several luminous flux, and polarizes the diffraction component in a specified direction. The divided reflected laser beams R0 (non-diffraction light, hereinafter called a 0th-order light), R1 (1st-order diffraction light), and R-1 (−1st-order diffraction light) are polarized toward the light-receiving areas provided to receive the laser beams. The hologram diffraction element 24 is a diffraction grating given a binary pattern. Of course, as explained below, a diffraction grating having a blaze pattern can be used.

As described above, the polarizing direction is changed 90° from the advancing path, and the reflected laser beams divided into a specified number R0, R1 and R-1 are reflected on the polarizing surface of polarization beam splitter 23, and condensed in the respective light-receiving areas of the photodetector 28 through the focusing lens 27.

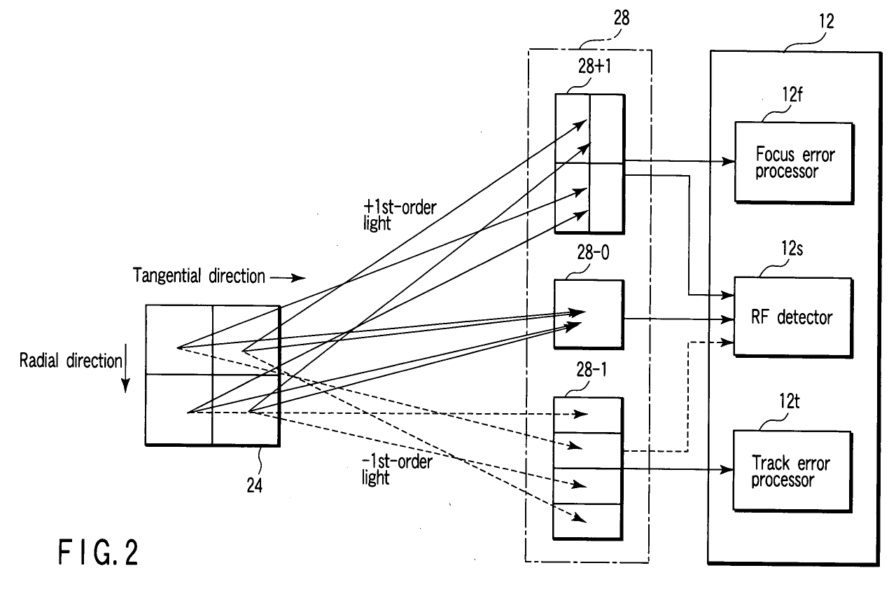

FIG. 2 shows the relationship between the reflected laser beam divided by the hologram diffraction element of the optical head unit and the light-receiving area on the light-receiving surface of the photodetector shown in FIG. 1.

As already explained above, the hologram diffraction element (HOE) 24 is a binary diffraction grating. Therefore, light (a reflected laser beam) passing through the hologram 24 is divided into 0th-order light R0, 1st-order diffraction light R1, and −1st-order diffraction light R-1. The hologram diffraction element 24 is divided into fixed numbers in the radial direction of the optical disc D, or in the tangential direction of the track (guide groove) or record mark string on the recording surface of the same optical disc.

The reflected laser beams R0, R1 and R-1 divided by the hologram diffraction element 24 are focused as an image in the 0th-order light detection area 28−0, 1st-order diffraction light detection area 28+1 and −1st-order diffraction light detection area 28−1 of the photodetector 28. Though not described in detail, the 1st-order diffraction light detection area 28+1 has a detection (light-receiving) area divided by two lines orthogonal to each other, and obtains a focus error signal by a know knife-edge method or a double knife-edge method, for example. The −1st-order diffraction light detection area 28−1 consists of a parallel arrangement of detection (light-receiving) areas of the number defined according to the numbers divided by the hologram diffraction element 24 (1×4 in the example of FIG. 2), and obtains a track error signal by a know phase contrast method.

The outputs from the detection areas are amplified to a specified level by an I/V converter (preamplifier, not shown), and supplied to the signal processing unit 12 in the subsequent stage.

The signal processing unit 12 has a focus error processor 12f and a track error processor 12t. The focus error processor 12f receives the output from the 1st-order diffraction light detection area 28+1. The track error processor 12e receives the output from the −1st-order diffraction light detection area 28−1. The RF detector 12s receives the outputs from the 0th-order light detection area 28-0 and 1st-order diffraction light detection area 28+1.

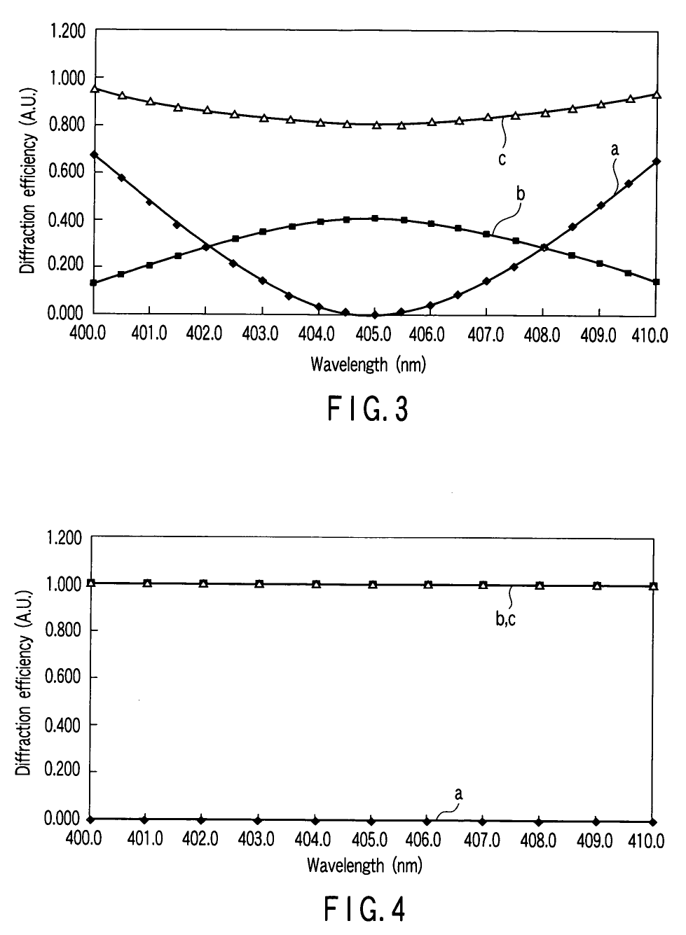

FIG. 3 and FIG. 4 show the relationship between the type of hologram diffraction element and the wavelength of a laser beam from a laser element and the diffraction efficiency in the optical disc apparatus shown in FIG. 1.

FIG. 3 shows the relationship between the wavelength of a laser beam and the diffraction efficiency, when a binary type hologram diffraction element is used. The curve a indicates the diffraction efficiency of the 0th-order light, the curve b indicates the diffraction efficiency of the +1st-order diffraction light, and the curve c indicates the diffraction efficiency of the 0th-order light plus ±1st-order light.

As seen from FIG. 3, the diffraction efficiency is highest in the 0th-order light plus ±1st-order diffraction light (the curve c).

As explained above, a signal reproduce system difficult to be influenced by changes in the laser beam wavelength can be achieved by using a binary type diffraction grating and adding the 0th-order light and ±1st-order diffraction light for the RF detection requiring a high signal level.

FIG. 4 shows the relationship between the laser beam wavelength and the diffraction efficiency, when the hologram diffraction element is a blaze type. The curve a indicates the diffraction efficiency of the 0th-order light, the curve b indicates the diffraction efficiency of the +1st-order diffraction light, and the curve c indicates the diffraction efficiency of the 0th-order light plus +1st-order diffraction light.

As seen from FIG. 4, the diffraction efficiency is 0 for the 0th-order light (the curve a), and high in the +1st-order diffraction light (the curve b) or the 0th-order light plus +1st-order diffraction light (the curve c).

Therefore, the ratio of an output signal to noise component, that is, signal-to-noise ratio can be increased by obtaining the RF signal from the 0th-order light and ±1st-order diffraction light when a binary type diffraction grating is used, and obtaining the RF signal from the 1st-order diffraction light or from the 0th-order light and +1st-order diffraction light when a blaze type diffraction grating is used.

Next, explanation will be given on another example of the optical disc apparatus shown in FIG. 1, which has a laser element to emit light with several wavelengths capable of recording and reproducing information on/from optical discs with different recording density.

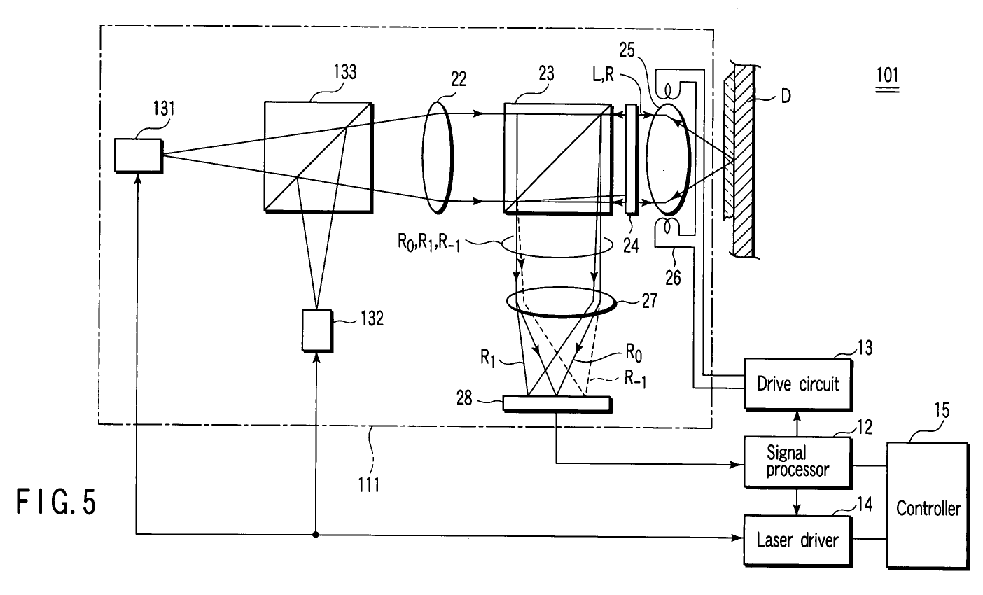

FIG. 5 shows another example of the optical disc apparatus shown in FIG. 1. In the optical disc apparatus shown in FIG. 5, the same reference numerals are given to the same or similar components as/to those shown in FIG. 5, and detailed explanation will be omitted. The optical disc apparatus shown in FIG. 5 is modified from the optical disc apparatus shown in FIG. 1, to be capable of recording, reproducing and erasing information on/from optical discs with different recording density.

The optical disc apparatus 101 shown in FIG. 5 has a first laser element 131 to output a laser beam with a first wavelength of 405 nm for example, a second laser element 132 to output a laser beam with a second wavelength of 650 nm different from the first wavelength, and an optical synthesizing element (a dichroic prism) 133 to overlay the laser beams from the first and second laser elements 131 and 132 on substantially the same optical path. The wavelength of the laser beam from the first laser element 131 may be 400-410 nm, for example. The wavelength of the laser beam from the second laser element 132 may be 645-655 nm.

The first and second laser elements 131 and 132 are assembled with the dichroic prism 133 in one body as an optical head unit 111.

The laser beam with the wavelength of 405 nm from the first laser element 131 is passed through a wavelength selection film of the dichroic prism 133, collimated by the collimator lens 22, passed through the polarization beam splitter 23 and hologram diffraction element 24, and guided to the objective lens 25. The laser beam with a wavelength of 405 nm given a fixed convergence by the objective lens 25 is passed through a not-described cover layer of an optical disc, and used for recording, reproducing and erasing information on/from a HD DVD optical disc with a track pitch of about 0.4 μm.

The laser beam with a wavelength of 650 nm from the second laser element 132 is reflected from the wavelength selection film of the dichroic prism 133, passed through the same optical path of the laser beam with a wavelength of 405 nm from the first laser element 131, collimated by the collimator lens 22, passed through the polarization beam splitter 23 and hologram diffraction element 24, and guided to the objective lens 25. The laser beam with a wavelength of 650 nm given a fixed convergence by the objective lens 25 is passed through a not-described cover layer of an optical disc, and used for recording, reproducing and erasing information on/from a HD DVD optical disc with a track pitch of about 0.68 μm.

The reflected laser beam with a fixed wavelength reflected on the recording surface of the optical disc D is captured by the objective lens 25, converted by the objective lens 25 to have a substantially parallel sectional beam shape, and returned to the polarization beam splitter 23.

The reflected laser beam returned to the polarization beam splitter 23 is reflected on the polarizing surface, and focused as an image on the light-receiving surface of the photodiode (photodetector) 28 through the focusing lens 27. The light-receiving surface of the photodetector 28 has arrangement of detection areas (light-receiving areas) and shape, which is set to meet the number of portions of the reflected laser beam divided into fixed number when passing through the hologram diffraction element 24, and the signal processing in the subsequent stage. Namely, the hologram diffraction element 24 is given a diffraction pattern capable of dividing the reflected laser beam into specified number of portions and shape corresponding to the arrangement and shape of detection areas of the photodetector 28.

The current outputted from each light-receiving part of the photodetector 28 is converted into a voltage by the I/V amplifier (not shown), and processed by a signal processing unit 12 to be usable for a RF (reproduce) signal, a focus error signal and a track error signal.

As explained in FIG. 2, the photodetector 28 has the 0th-order light detection area 28−0 to receive the 0th-order light (non-diffracted light) R0 among the reflected laser beam divided by the hologram diffraction element 24, +1st-order light detection area 28+1 to receive the +1st-order diffraction light) R1, and −1st-order light detection area 28−1 to receive the −1st-order diffraction light R-1.

The outputs from the detection areas are amplified to a fixed level by the not-shown I/V converter (preamplifier), and supplied to the signal processing unit 12 in the subsequent stage.

As shown in FIG. 3 and FIG. 4, the relationship between the types of hologram diffraction element and the wavelength of a laser beam from a laser element and the diffraction efficiency in the optical disc apparatus shown in FIG. 5 is shown. In this case, only one type of diffraction element (hologram diffraction element) is used in the optical disc apparatus shown in FIG. 1. Therefore, explanation will be given on the case that a laser beam with a wavelength of 650 nm is passed through a diffraction element designed for a wavelength of 405 nm.

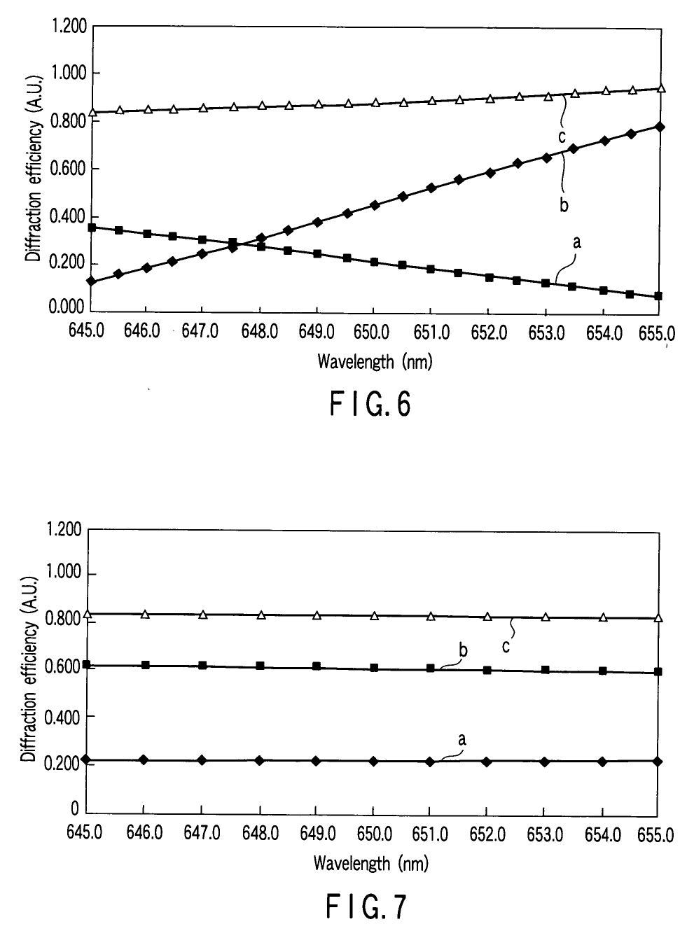

FIG. 6 shows the relationship between the wavelength of a laser beam (650 nm) and the diffraction efficiency, when a binary type hologram diffraction element is used. The curve a indicates the diffraction efficiency of the 0th-order light, the curve b indicates the diffraction efficiency of the +1st-order diffraction light, and the curve c indicates the diffraction efficiency of the 0th-order light plus ±1st-order light.

As seen from FIG. 6, the diffraction efficiency is highest in the 0th-order light plus ±1st-order diffraction light (the curve c), even when a laser beam with a wavelength of 650 nm is passed through a binary diffraction grating designed for a wavelength of 405 nm.

FIG. 7 shows the relationship between the wavelength of a laser beam and the diffraction efficiency, when a blaze type hologram diffraction element is used and a laser beam with a wavelength of 650 nm is passed through a diffraction element designed for a wavelength of 405 nm. The curve a indicates the diffraction efficiency of the 0th-order light, the curve b indicates the diffraction efficiency of the +1st-order diffraction light, and the curve c indicates the diffraction efficiency of the 0th-order light plus ±1st-order light.

As seen from FIG. 7, a fixed level diffraction efficiency is obtained for the 0th-order light (the curve a) when a laser beam with a wavelength of 650 nm is passed through the diffraction grating designed for a wavelength of 405 nm, and the efficiency is increased for the +1st-order diffraction light (the curve b). Therefore, the diffraction efficiency is highest for the 0th-order light plus +1st-order diffraction light (the curve c).

Namely, a fixed level diffraction efficiency can be obtained even when a laser beam with a wavelength of 650 nm is passed through a blaze grating having a diffraction pattern designed to meet a laser beam with a wavelength of 405 nm.

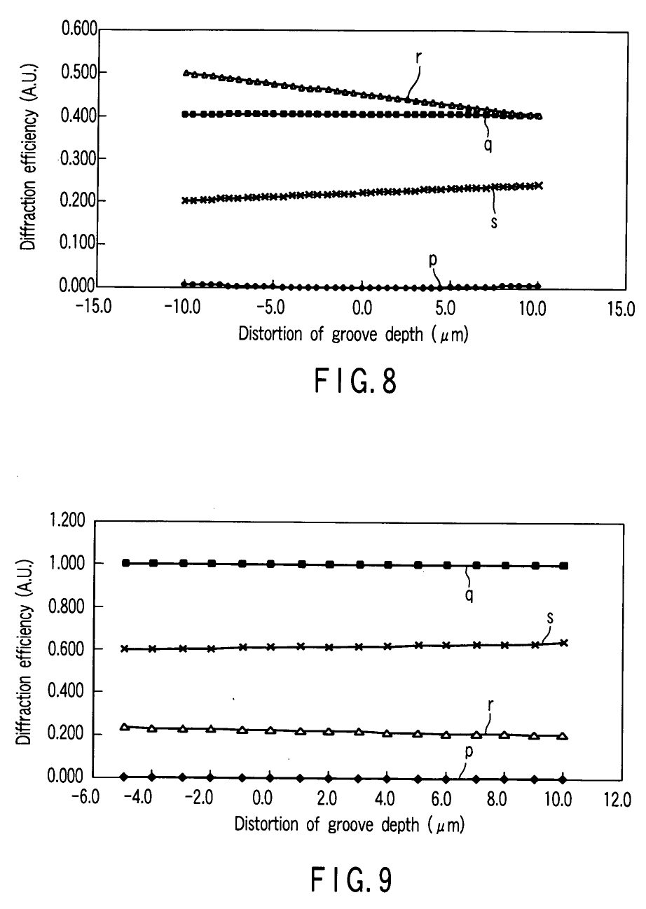

FIG. 8 shows the deviation of the depth (depth distortion) of the groove of the binary diffraction grating shown in FIG. 3 and FIG. 6, and the diffraction efficiency of a laser beam with a wavelength of 405 nm (for the HD DVD standard) and a laser beam with a wavelength of 650 nm (for the (current) DVD standard).

As shown in FIG. 8, the deviation of the depth (depth distortion) of the groove of the binary diffraction grating changes little in the 0th-order light of the laser beam with a wavelength of 405 nm (the curve p), and changes about 20% in the +1st-order diffraction light of the laser beam with a wavelength of 405 nm (the curve q). The change is about 40% in the 0th-order light of the laser beam with a wavelength of 650 nm (the curve r) and +1st-order diffraction light (the curve s).

FIG. 9 shows the deviation of the depth (depth distortion) of the groove of the blaze diffraction grating shown in FIG. 4 and FIG. 7, and the diffraction efficiency of a laser beam with a wavelength of 405 nm (for the HD DVD standard) and a laser beam with a wavelength of 650 nm (for the (current) DVD standard).

As shown in FIG. 9, the deviation of the depth (depth distortion) of the groove of the binary diffraction grating changes little in the 0th-order light of the laser beam with a wavelength of 405 nm (the curve p), and changes about 100% in the +1st-order diffraction light of the laser beam with a wavelength of 405 nm (the curve q). The change is about 20% in the 0th-order light of the laser beam with a wavelength of 650 nm (the curve r), and about 60% in the +1st-order diffraction light (the curve s).

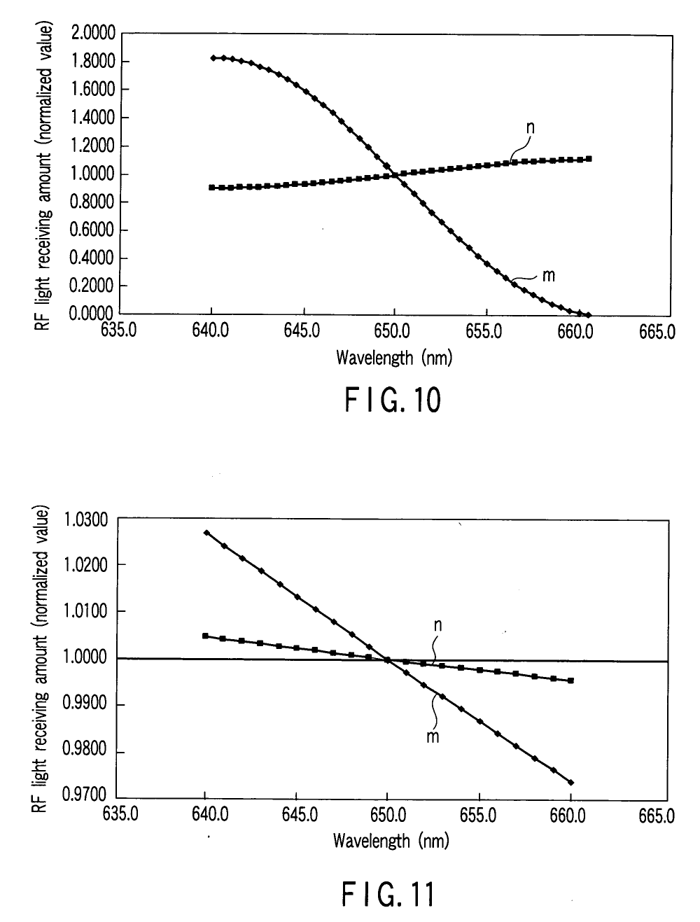

FIG. 10 and FIG. 11 show a change in the output with respect to a change in the wavelength, when obtaining a reproduce signal of the DVD optical disc explained in FIG. 6 and FIG. 9, as a +1st-order diffraction light (the curve m) or the sum of 0th-order light and ±1st-order diffraction light. The RF light receiving amount (the vertical axis) indicates the amount of change from a reference value.

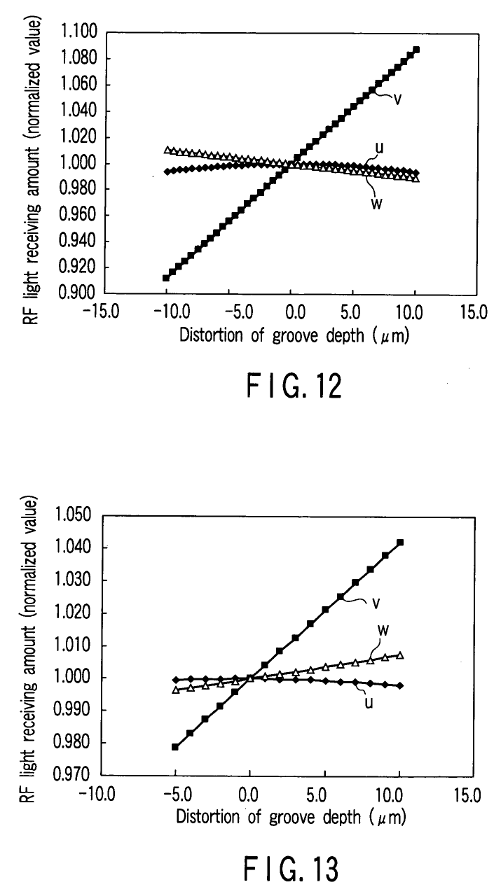

FIG. 12 and FIG. 13 show the degree of the change in the output with respect to the change in the depth of the groove for HD DVD. In FIG. 12 and FIG. 13, the curve u indicates a wavelength of 405 nm (for HD DVD), the curve v indicates a ±1st-order diffraction light with a wavelength of 650 nm (for DVD), and the curve w indicates the sum of ±1st-order diffraction light and 0th-order light.

As explained above, when a hologram diffraction element is a binary type or blaze type in an optical disc apparatus, a blaze grating is theoretically 1 in the diffraction efficiency. But, an actual blaze grating is often a stepwise pseudo-blaze, and the diffraction efficiency is about 0.7 if the number of steps is few. If this condition is applied to a binary type diffraction grating, the diffraction efficiency is increased to about 0.8.

When making information of both HD DVD and DVD discs playable, in the blaze hologram diffraction element optimized in HD DVD (designed for a wavelength of 405 nm), the amount of light of a detected light (a reflected laser beam) can be efficiently ensured (the amount of detection light can be increased) for a DVD standard disc, when detecting a RF signal from a 0th-order plus +1st-order diffraction light, rather than detecting from only the +1st-order diffraction light.

In the binary hologram diffraction element optimized in HD DVD (designed for a wavelength of 405 nm), the amount of light of a detected light (a reflected laser beam) can be efficiently ensured (the amount of detection light can be increased) for a DVD standard disc, when using a 0th-order light plus ±1st-order diffraction light (the sum of all of 0th-order light, +1st-order diffraction light and −1st-order diffraction light), rather than using any of +1st-order diffraction light, −1st-order diffraction light, and the sum of +1st-order diffraction light and −1st-order diffraction light.

Namely, as a result of calculation, when a binary type is used (0th-order light and ±1st-order diffraction light are generated), it is better as RF to add the 0th-order light and ±1st-order diffraction light, rather than using only the ±1st-order diffraction light. when a blaze type is used (0th-order light and +1st-order diffraction light are generated), it is preferable as RF to add the 0th-order light and +1st-order diffraction light, rather than using only the +1st-order diffraction light.

For example, as shown in FIG. 11, if the groove depth is changed when using a blaze type diffraction grating, the amplitude of RF signal in any of HD and DVD is as follows.

When the +1st-order diffraction light receiving amount in RF (HD) is 1.0,

the +1st-order diffraction light receiving amount in RF (DVD) is 0.612, and

when the 0th-order light plus +1st-order diffraction light is used in RF (DVD), the light receiving amount is 0.836.

The fluctuation rate of the RF signal amplitude in HD/DVD is −0.0001[1/nm] for the +1st-order diffraction light in RF(HD), and

−0.0042[1/nm] for the +1st-order diffraction light in RF(DVD).

If the 0th-order light plus +1st-order diffraction light is used in RF(DVD), the fluctuation rate is 0.0007[1/nm].

Comparing the 0th-order light plus +1st-order diffraction light with the 1st-order light as a RF signal in DVD, the RF fluctuation rate by the groove depth is ¼ and the light receiving amount is 1.4 times.

Likewise, as shown in FIG. 13, the RF fluctuation rate by a wavelength is ⅙.

As shown in FIG. 11, when the groove depth is changed and the diffraction grating is a binary type, the RF signal amplitude is as follows in either HD or DVD.

When the ±1st-order diffraction light receiving amount in RF(HD) is 0.811, the signal amplitude is 0.444 in RF(DVD).

When the 0th-order light plus ±1st-order diffraction light is used in RF(DVD), the amplitude is 0.896.

The fluctuation rate of the RF signal amplitude in HD/DVD is −0.0001[1/nm] for the ±1st-order diffraction light in RF(HD), and −0.004[1/nm] for the ±1st-order diffraction light in RF(DVD).

If the 0th-order light plus ±1st-order diffraction light is used in RF(DVD), the fluctuation rate is −0.001[1/nm].

Comparing the 0th-order light plus ±1st-order diffraction light with the ±1st-order light as a RF signal in DVD, the RF fluctuation rate by the groove depth is ¼ and the light receiving amount is 2 times.

Likewise, as shown in FIG. 13, the RF fluctuation rate by a wavelength is 1/9.

As explained above, the 0th-order light and +1st-order diffraction light, or all of the 0th-order light, +1st-order diffraction light and −1st-order diffraction light of the divided reflected laser beams can be supplied by adding to the detection of RF signal to meet the characteristics of a diffraction grating, and the amount of light can be increased with a reduced fluctuation. This provides an allowance in the signal processing system provided in the subsequent stage, and stabilizes the reproduce of a signal from an optical disc having a recording layer with a low reflectivity or a disc having more than one recording layer and intermediate layer. Therefore, the reliability as an optical disc apparatus is increased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

What is claimed is:

1. An optical head unit comprising:
an objective lens to capture light reflected on the recording surface of a recording medium;
an optical diffraction element to diffract the light captured by the objective lens in a direction predetermined according to the wavelength of the light;
a first photodetector which detects a non-diffracted light passing through the optical diffraction element, and creates an output signal with the largeness corresponding to the intensity of the light;
a second photodetector which detects the light diffracted by the optical diffraction element at a position predetermined according to the diffraction angle, and creates an output signal with the largeness corresponding to the intensity of the light; and
a signal output unit which outputs a signal by adding an output corresponding to at least one component of the diffracted light among the output from the second photodetector, to the output from the first photodetector.

2. The optical head unit according to claim 1, wherein the second photodetector outputs by adding outputs corresponding to all the diffracted light from the second photodetector.

3. An optical head unit comprising:
an objective lens to capture light reflected on the recording surface of a recording medium;
an optical diffraction element which has a fixed diffraction efficiency for light with a first wavelength, light with a second wavelength different from the first wavelength and light with a third wavelength, and diffracts the light captured by the objective lens in a direction predetermined according to the wavelength of the light;
a first photodetector which detects a non-diffracted light passing through the optical diffraction element, and creates an output signal with the largeness corresponding to the intensity of the light;
a second photodetector which detects the light diffracted by the optical diffraction element at a position predetermined according to the diffraction angle, and creates an output signal with the largeness corresponding to the intensity of the light; and
a signal output unit which outputs a signal by adding an output corresponding to at least one component of the diffracted light among the output from the second photodetector, to the output from the first photodetector.

4. The optical head unit according to claim 3, wherein the second photodetector outputs a signal by adding outputs corresponding to all the diffracted light from the second photodetector.

5. The optical head unit according to claim 3, wherein the optical diffraction element is a binary type to generate a non-diffracted light and a ±1st-order diffraction light.

6. The optical head unit according to claim 4, wherein the optical diffraction element is a binary type to generate a non-diffracted light and a ±1st-order diffraction light.

7. The optical head unit according to claim 3, wherein the optical diffraction element is a blaze type to diffract a passing light to a non-diffracted light and a +1st-order diffraction light in a specified direction.

8. The optical head unit according to claim 4, wherein the optical diffraction element is a blaze type to diffract a passing light to a non-diffracted light and a +1st-order diffraction light in a specified direction.

9. An optical disc apparatus comprising:
an optical head unit which includes an objective lens to capture light reflected on the recording surface of a recording medium; an optical diffraction element to diffract the light captured by the objective lens in a direction predetermined according to the wavelength of the light; a first photodetector which detects a non-diffracted light passing through the optical diffraction element, and creates an output signal with the largeness corresponding to the intensity of the light; a second photodetector which detects the light diffracted by the optical diffraction element at a position predetermined according to the diffraction angle, and creates an output signal with the largeness corresponding to the intensity of the light; and a signal output unit which outputs a signal by adding an output corresponding to at least one component of the diffracted light among the output from the second photodetector, to the output from the first photodetector; and
a signal processing unit which reproduces information recorded in the recording medium from an output of the signal processor.
